(19) United States
(12) Patent Application Publication
(10) Pub. No.: US 2008/0156080 A1
(43) Pub. Date: Jul. 3, 2008

(54) METHODS AND SYSTEMS FOR MULTIDIMENSIONAL CONCENTRATION AND SEPARATION OF BIOMOLECULES USING CAPILLARY ISOTACHOPHORESIS

(75) Inventor: Brian M. Balgley, Annandale, VA (US)

Correspondence Address: PILLSBURY WINTHROP SHAW PITTMAN, LLP, P.O. BOX 10500, MCLEAN, VA, 22102, US

(73) Assignee: Calibrant Biosystems, Inc., Rockville, MD (US)

(21) Appl. No.: 11/619,054

(22) Filed: Jan. 2, 2007

(51) Int. Cl. G01N 30/02; G01N 21/00; G01N 30/84; G01N 37/00

(52) U.S. Cl. 73/61.47; 73/61.48; 73/61.53; 73/61.55

(57) ABSTRACT

The invention provides a method for performing off-line multi-dimensional separation and analysis of a heterogeneous biomolecular sample. The method includes separating the heterogeneous biomolecular sample into a plurality of fractions using an, at least partially, capillary isotachophoresis mechanism. The plurality of fractions are then transferred to a liquid chromatography apparatus where they are each separated into a plurality of sub-fractions. The sub-fractions are then analyzed to determine their constituent molecules.

### CROSS REFERENCE TO RELATED APPLICATIONS

This application is related to co-pending U.S. Patent Application No. (Attorney Docket No. 016474-0353161), entitled “Methods and Systems for Off-Line Multidimensional Concentration and Separation of Biomolecules” filed herewith, which is hereby incorporated by reference herein in its entirety.

### STATEMENT REGARDING FEDERALLY SPONSORED RESEARCH

The U.S. Government may have certain rights in this invention as provided for by the terms of Grant Numbers R43 CA103086, R44 CA107988, and R44 RR022667 awarded by the National Institutes of Health.

### FIELD OF THE INVENTION

The invention relates to a method for multidimensional separation using capillary isotachophoresis in the first dimension, transfer of samples to the second dimension, and liquid chromatography in the second dimension.

### BACKGROUND

Identification and analysis of biomolecules is crucial for modern scientific discovery. Identification and analysis of proteins and other peptides is especially important, as proteomic analysis provides practical information regarding cellular function. While genomic analysis provides an abstracted view of the probable organization and function of biological systems, proteomic analysis enables a practical understanding of actual gene expression, enables identification and study of active biological pathways, and otherwise provides useful information regarding actual functioning of biological systems.

Proteomic analysis in the field of cancer is particularly important. Predictions of cancer behavior and likely drug response and resistance have been confounded by the great complexity of the human genome and, very often, the cellular heterogeneity of tumors. While analyses of DNA and RNA expression profiles through techniques including cDNA microarrays, comparative genomic hybridization, loss of heterozygosity (LOH), and single nucleotide polymorphism (SNP) analysis are important in identifying genetic abnormalities and uncovering the molecular dysfunctions existing in tumor cells, the presence of SNPs, changes in DNA copy numbers, or altered RNA levels may have little or no effect on the events actually happening at the protein level. Although many genes are possibly associated with the onset, progression, and/or severity of cancer, the specific roles played by the majority of these genes are yet to be clearly elucidated at the protein level, and only a small number have been clinically validated or associated with clinical phenotype.

Proteomics will therefore contribute greatly to our understanding of gene function in the post-genomics era, impacting disease related research from early diagnosis to the identification of targets for drug screening and development. However, biologically relevant proteomics data can best be generated if the samples investigated consist of homogeneous cell populations, in which no unwanted cells of different types and/or development stages obscure the results. Thus, technologies such as laser capture microdissection (LCM) technology have been developed to provide a rapid and straightforward method for procuring homogeneous subpopulations of cells for biochemical and molecular biological analyses. In the absence of PCR-like protein amplification techniques, current proteome platforms, including two-dimensional polyacrylamide gel electrophoresis (2-D PAGE) and shotgun-based multidimensional liquid chromatography separations, require substantially larger cellular samples which are generally incompatible with protein extract levels obtained from small cell populations and limited tissue samples. While limited 2-D PAGE analyses of microdissection-derived tissue samples have been attempted, these studies require significant manual effort and time to extract sufficient levels of protein for analysis, while providing little information on protein expression beyond a relatively small number of high abundance proteins. In addition, the 2-D PAGE-MS approach itself suffers from low throughput and poor reproducibility, and remains lacking in proteome coverage, dynamic range, and sensitivity.

Shotgun identification of protein mixtures by proteolytic digestion followed with multidimensional liquid chromatography and tandem mass spectrometry (MS) has been used to separate and fragment peptides. Total peak capacity improvements in multidimensional chromatography platforms have increased the number of detected peptides and proteins identified due to better use of the MS dynamic range and reduced discrimination during ionization. To increase the proteome coverage, particularly for the identification of low abundance proteins, these peptide-based proteome technologies often require large quantities of enzymatically/chemically cleaved peptides, ranging from a few milligrams to several hundred micrograms and are generally incompatible with protein levels extracted from microdissection-procured tissue samples. Thus, the reported tissue proteomic studies employing multidimensional liquid chromatography separations are mainly based on the analysis of entire tissue blocks instead of targeted subpopulations of microdissection-derived cells. Additionally, multidimensional liquid phase separations have been employed for the resolution of intact proteins obtained from ovarian carcinoma cell lines.

Cells isolated from fresh frozen tumor tissues have been directly analyzed using matrix-assisted laser desorption/ionization-mass spectrometry (MALDI-MS). The m/z signals or peaks obtained from MALDI-MS are correlated with protein distribution within a specific region of the tissue sample and can be used to construct ion density maps or specific molecular images for virtually every signal detected in the analysis. While surface-enhanced laser desorption/ionization-mass spectrometry (SELDI-MS) has been reported as a relatively simple, rapid, and sensitive protein biomarker analysis tool with potential clinical utility, the transition of protein pattern produced by SELDI-MS to protein identity is generally quite difficult. The efforts typically involve tracking the specific peak of interest through a number of chromatography and gel purification steps to ensure that the peptides measured in the proteolytic digest are mainly derived from the protein of interest. The inherent large-scale and the difficulty of this protein identification process not only accounts for both the small number of proteins identified and the tendency toward the identification of highly abundant proteins, but also calls into question the practicality of the SELDI-MS approach when working with limited clinical samples and microdissected tissue specimens.

In addition to the benefits offered by analytical techniques which are compatible with small sample sizes, effective proteome analysis benefits from techniques that, inter alia, provide high resolution analysis of proteins and which can access a large range of protein abundance. Fortunately, multidimensional separation techniques can serve to reduce the dynamic range of individual fractions of analyte while maintaining high overall separation resolution, especially those techniques that utilize orthogonal separation mechanisms.

As such, there is a need to provide systems and methods improved multidimensional separation of low abundance biomolecules, including proteins or other peptides utilizing orthogonal separation techniques.

Assuming separation techniques used in a two dimensional separation are orthogonal, the peak capacity of 2-D separations is the product of the peak capacities of individual one-dimensional methods. Thus, various non-gel-based 2-D separation schemes have been developed to resolve complex peptide/protein mixtures prior to mass spectrometry analysis. In addition to a biphasic microcapillary column packed with strong cation exchange and reversed-phase packing materials, several interfaces have been developed for coupling two different modes of LC as well as LC as a first-dimension separation with capillary zone electrophoresis (CZE) in the second dimension.

These interfaces include storage loops, switching valves with two parallel columns, and flow gating. Recently, the use of switching valves has also been adopted for coupling CIEF with capillary electrochromatography (CEC).

In contrast to performing LC prior to a second-dimension electrokinetic separation, LC can follow a first-dimension electrokinetic separation. This modality takes advantage of the high analyte concentration effect possible with electrokinetic separations and couples it with an orthogonal separation mechanism in the form of LC. In order to collect discrete fractions without loss, it is typically necessary to dilute the fraction(s) containing the separated sample. An advantage to using LC as the second-dimension separation mechanism is the ability to perform head-column stacking of the sample during the sample loading process and prior to the LC separation. In this process, the sample binds at the head-end of the column to which it is being loaded and is subject to non-eluting mobile-phase flow conditions such that non-binding salts and other matrices elute to waste. This process allows for near-complete recovery and cleanup of the sample in the diluted fraction prior to the application of a mobile phase eluting gradient flow for the second-dimension separation. It should be noted that head-column stacking may be performed on either the separation column or a pre-column typically referred to as a trap-column.

### SUMMARY OF THE INVENTION

The invention provides systems and methods for multi-dimensional separation of relatively low abundance biomolecules using capillary electrophoresis (CE) in the first dimension and liquid chromatography (LC) in the second dimension. In some embodiments, the systems and methods of the invention provide particular benefits for analysis of low abundance biomolecules such as, for example, the proteins present in a proteome sample below a concentration of several tens of ng/mL, and for the analysis of small total biomolecular sample amounts such as, for example, total protein amounts of between about 1 to 10 micrograms. In one embodiment, the invention includes a system and method for multi-dimensional separation and concentration of biochemical samples that include performing a first dimension separation using transient capillary isotachophoresis (CITP) or transient capillary isotachophoresis/capillary-zone electrophoresis (CITP/CZE), followed by a second dimension separation using reverse-phase liquid chromatography (RPLC), with either on-line (direct transfer) or off-line (indirect transfer) coupling between separation dimensions. Transient CITP/CZE refers to the process in which CITP occurs at the beginning of the separation and then transitions to CZE as the leading electrolyte exits the separation capillary

The use of CITP or CITP/CZE in place of other CE methods as the first separation dimension offers several advantages, including selective concentration of trace compounds for enhanced low abundance protein analysis, less sensitivity to protein or peptide precipitation during sample stacking due to the charged nature of sample components, and potentially greater coverage of peptides/proteins with extreme pi values. In addition, CITP/CZE offers benefits for proteome analysis from samples such as formalin-fixed paraffin-embedded tissues. Because analyte recovery is part of the separation step in CITP/CZE, uncharged species do not mobilize and therefore do not leave the capillary. This provides CITP/CZE-LC-MS/MS a greater tolerance for such species, which can include common contaminants resulting from typical sample preparation procedures such as plastic polymers from storage containers, as well as polyethylene glycol and paraffin waxes, both widely used tissue preservatives. This allows for fewer sample preparation procedures prior to CITP/CZE. CITP/CZE-LC-MS/MS also reduces matrix effects commonly seen in the electrospray ionization and mass spectrometric ion detection processes from such contaminants. CITP/CZE also results in a higher resolution separation than other CE methods when separating complex peptide mixtures, and thus less overlapping between sequential fractions eluted from the CITP/CZE capillary. This results in higher numbers of peptide sequences detected and identified and, consequently, higher numbers of proteins inferred. Observations indicate a 50% improvement in numbers of peptide sequences identified by CITP/CZE vs. other CE methods.

In one embodiment, the invention includes performing a first dimension separation on a heterogeneous biomolecular sample using a CITP-enabled CE apparatus to produce multiple sample fractions. In some embodiments, CITP alone, CITP/CZE, or other CITP coupled CE methods may be performed to separate the heterogeneous biomolecular sample.

The sample fractions may then be transferred to a second dimension separation apparatus. In some embodiments, the transfer may include a direct or “on-line” transfer in which the first dimension separation apparatus is coupled to the second dimension separation apparatus. In some embodiments, this direct transfer mechanism may include trap columns as an intermediary between separation methods. In some embodiments, transfer from the first dimension separation apparatus to the second dimension separation apparatus may be an indirect or “off-line” transfer, such as described in co-pending U.S. Application No. (Attorney Docket No. 016474-0353161), entitled “Methods and Systems for Off-Line Multidimensional Concentration and Separation of Biomolecules,” which is hereby incorporated by reference herein in its entirety.

In some embodiments, the second dimension separation apparatus may be a liquid chromatography apparatus such as, for example, a capillary reversed-phase liquid chromatography apparatus. Once transferred to the second dimension separation apparatus, sample fractions may be separated into a plurality of sub-fractions. The separated sub-fractions may then be subject to eluting conditions and eluted from the second dimension separation apparatus. As each sub-fraction is eluted from the apparatus, the sub-fraction may be collected and/or analyzed, using, for example, mass spectrometry, to determine the sample constituents of the sub-fraction.

These and other objects, features, and advantages of the invention will be apparent through the detailed description and the drawings attached hereto. It is also to be understood that both the foregoing general description and the following detailed description are exemplary and not restrictive of the scope of the invention.

### BRIEF DESCRIPTION OF THE DRAWINGS

FIG. 1 illustrates an example of a process for multidimensional separation of biomolecules using CITP.

FIG. 2 illustrates an example of an on-line system for multidimensional separation of biomolecules using CITP.

FIG. 3 illustrates an example of an off-line system for multidimensional separation of biomolecules using CITP.

### DETAILED DESCRIPTION

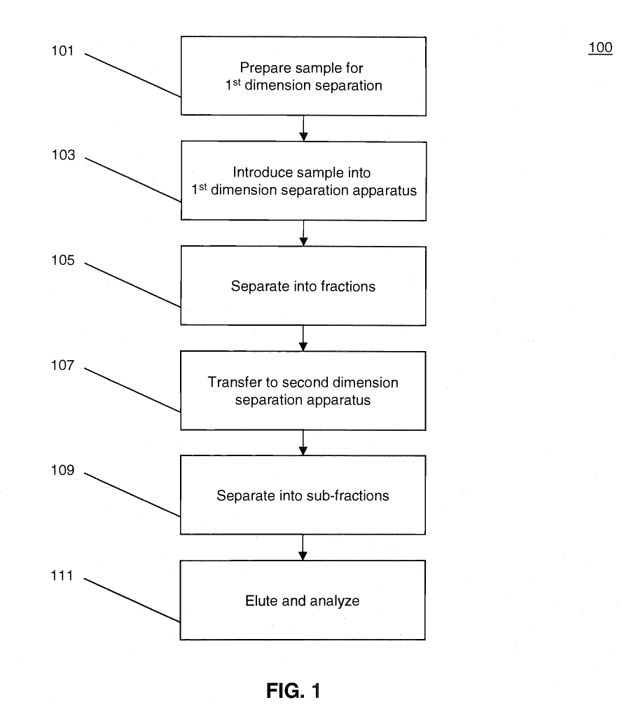

FIG. 1 illustrates a process 100 for performing multidimensional separation of heterogeneous biomolecular samples using CITP in the first dimension. An example of heterogenous biomolecular samples as used herein may include a heterogeneous sample of proteins or other peptides such as, for example, those prepared in Jinzhi Chen et al., Capillary Isoelectric Focusing-Based Multidimensional Concentration/Separation Platform for Proteome Analysis, Analytical Chemistry, Vol. 75, No. 13, July 2003.

Process 100 includes an operation 101, wherein a heterogeneous biomolecular sample may be prepared for multi-dimensional separation and analysis. Operation 101 may include one or more preparation techniques designed to facilitate first dimension separation, second dimension separation, analysis of sample constituents, and/or other operations. For example, if the biomolecular sample comprises a mixture of proteins and/or peptides, the sample may be treated with a detergent such as, for example, sodium dodecyl sulfate (SDS) or other detergent, to denature proteins, dissolve proteins, and/or otherwise treat proteins prior to separation and/or analysis.

In an operation 103, the heterogeneous biomolecular sample is introduced into a first dimension separation apparatus. As discussed herein, the apparatus used for the first dimension separation may depend on the characteristics selected for in the first dimension, the separation range needed, the acceptable error rate, the convenience of the apparatus in conjunction with other factors, and/or other factors.

In an operation 105, the first dimension separation apparatus may be used to separate the heterogeneous biomolecular sample into a plurality of fractions based on one or more characteristics of the fractions. In some embodiments, the first dimension separation apparatus may comprise a capillary isotachophoresis (CITP) apparatus or a capillary isotachophoresis/capillary-zone electrohporesis (CITP/CZE) apparatus, which separate biomolecular samples based on size and/or charge. The CITP or CITP/CZE apparatus may include a capillary wherein a separation media resides. During separation of the biomolecular sample using CITP or CITP/CZE, an electric current is applied across the capillary, thus motivating the sample constituents to migrate through the separation media at different speeds based on size and charge. This migration separates the heterogenous biomolecular sample into the plurality of fractions based on common size and/or charge. CITP or CITP/CZE is accomplished by loading a sample into a capillary pre-filled with a buffer (0.1 M acetic acid) by either pressure of electrokinetic means, such that the capillary is partially filled with sample. When using a CITP/CZE apparatus, the degree to which the capillary is filled with sample will affect the transition point from CITP to CZE and thus influence the separation. The ends of the capillary are then connected to vials or flows containing the buffer (0.1 M acetic acid) and a positive current is supplied to the inlet end while the outlet end is connected to ground. This current motivates the separation.

CITP is sometimes used for analyte preconcentration prior to electrophoretic separation. However, the application of CITP to selectively enrich trace amounts of proteins or peptides in complex mixtures can significantly improve comprehensive proteome analysis, particularly toward the identification of low abundance proteins. While displacement chromatography has also been reported as an approach to selective enrichment of low abundance peptides, CITP offers the benefits of speed, straightforward manipulation/switching between the stacking and separation modes in transient CITP/capillary zone electrophoresis (CITP/CZE), and no need for column regeneration, including the removal of bound displacers. In addition, displacement chromatography is typically operated at the preparative-scale and is incompatible with minute proteins extracted from small cell populations and limited tissue specimens.

As opposed to universally enriching all proteins by a similar degree in most sample concentration techniques, the CITP stacking process specifically targets trace amounts of proteins and thus drastically reduces the range of relative protein abundances for providing unparalleled advantages towards the identification of low abundance proteins. An important aspect of the multidimensional separation platform is its ability to improve the detection of analytes present in low quantities during the analyses of complex protein/peptide mixtures. Selective proteome enrichment enabled by the CITP process can be represented by the Kohirausch equation:

C_{A}=C_{L}/{[μ_{L}/(μ_{L}+μ_{R})][(μ_{A}+μ_{R})/μ_{A}]}

where C_{L} is the molarity of the leading electrolyte; C_{A} is the analyte concentration in the stacked zone; and μ is the electrophoretic mobility (the subscript R refers to the counter ion). Based on this equation, it can be concluded that the final concentration of the analyte, C_{A}, is largely proportional to the molarity of the leading buffer, C_{L}. Depending on the initial concentrations of individual sample components relative to the molarity of the leading buffer, the result of the CITP stacking process is that major compounds may be diluted, but trace peptides are concentrated.

As a selective enrichment technique, it should also be noted that the final concentration of the analyte in CITP is independent from the applied electric voltage. However, the application of low electric field strengths may lead to poorer resolution among the stacked zones and longer migration time in CITP. By comparing with the use of CIEF as a first separation dimension, CITP may offer a broader field of application in some embodiments. Peptides with extreme pl values may be outside the working pH range of CIEF due to limited availability of commercial ampholytes for the creation of a pH gradient inside the capillary. Furthermore, analytes focused in CIEF reside at their pls where they have an increased tendency to precipitate. In contrast, the stacked peptides in CITP are less prone to precipitation due to their charged nature.

In order to obtain excellent separation resolution in CITP, the operational electrolyte system should be optimized to give appropriate differences among the effective mobilities of analytes. As the pH and ionic strength of the stacked zones in CITP are different from each other, optimization of the separation in CITP is not straightforward in comparison with CZE. Thus, on-column transition of CITP to CZE may be used to further optimize selective analyte enrichment in CITP and the subsequent separation resolution achieved using CZE. For transient CITP/CZE, two elements may be performed: (1) the mobility of the co-ion of the background electrolyte (e.g. 0.1 M acetic acid at pH 2.8) should be low during the transient CITP step so that it can serve as the terminating ion; and (2) the proteome sample should also contain an additional co-ion (e.g. 20 mM ammonium acetate) with high electrophoretic mobility as the leading electrolyte. Under the influence of the applied electric field, the higher mobility ammonium ions rush to the frontal boundary of the sample zone and the sample stacks between the high-mobility leading electrolyte and the low-mobility terminating electrolyte in the background electrophoresis buffer. Transient CITP is followed by CZE of concentrated peptides in the background electrolyte. It should be noted that additional band broadening occurs as soon as CITP ends and CZE starts. This is caused by diffusion and dilution within the background electrolyte. For transient CITP/CZE, significant enhancement in separation resolution is therefore accompanied with the expense of a minor loss in analyte stacking.

Capillaries (e.g. 100 μm i.d./200 μm o.d.) may be coated with hydroxypropyl cellulose for the elimination of electroosmotic pumping and analyte adsorption. The capillary may be initially filled with a background electrophoresis buffer (e.g. 0.1 M acetic acid). Ammonium acetate, which may serve as the leading electrolyte, may then be added to the peptide sample. Several important factors, including the volume and the concentration of the sample plug, the overall capillary length, the applied electric voltage, and the concentration of leading electrolyte, can be tuned to optimize the transient CITP/CZE process for sample loading, selective concentration factor, overall resolving power, and speed of the separation. Furthermore, the use of formic acid may be used to improve the solubility of hydrophobic proteins and peptides. Besides the use of acetic acid, formic acid may thus be employed as the terminating electrolyte in the background electrophoresis buffer and investigated for its effect on transient CITP/CZE separations while enhancing analyte solubility in the stacked zones.

In the first dimension CE separation, the capillary inner diameter may affect separation performance. A large capillary diameter can lead to the generation of excessive Joule heating, while a small capillary diameter can significantly limit the amount of sample molecules which may be loaded into the apparatus. As such, in some embodiments, a silica capillary having an inner diameter of around 100 microns may be used to enable sufficient sample loading for highly sensitive detection of analyte molecules while limiting the heat generation below a level which would lead to excessive molecular dispersion during the CE separation. In some embodiments, the electrophoresis capillary may be coated with a material designed to reduce electroosmotic flow such as, for example, hydroxypropyl cellulose.

In an operation 107, the one or more separated sample fractions are transferred to the second dimension separation apparatus. In some embodiments, transfer may utilize a coupled on-line approach as described by Chen et al. The ability to directly couple the separation dimensions using such an on-line approach may be desirable to prevent dilution or sample loss during transfer, and all known reports of platforms which couple first-dimension CE separations with second-dimension LC separations are based on this on-line approach. Using the on-line approach as described by Chen et al., the charge-resolved peptides in the CITP capillary are sequentially and electrokinetically loaded into an injection loop in a 6-port microinjection valve. In some embodiments, the microinjection valves may be manually operated. In some embodiments, the valves may be operated through an automated electrical actuation mechanism, provided the actuator is sufficiently isolated from the fluidic ports to prevent electrical shorting between fluid within the valve and the valve's electronics. The valve should also provide sufficient electrical isolation among multiple ports to prevent current leakage and electrical crosstalk between the ports. The loaded peptides in the injection loop are introduced into a short C₁₈ reversed-phase trap column using a syringe pump through a 6-port microselection valve. Repeated peptide loadings and injections into various trap columns are carried out until the entire CITP capillary content is sampled. As the peptides are present in narrowly stacked zones, a number of efforts, including the selection of a microinjection valve with a dead volume of only 60 nL, the match of inner diameters between the CITP capillary and capillary trap columns, and the application of head-column stacking in trap columns, may be employed to minimize peptide dilution and mixing during the transfer between the first and second separation dimensions.

In some embodiments, off-line transfer methods such as those described in co-pending U.S. Patent Application No. (Attorney Docket No. 016474-0353161), may be used to transfer from first to second dimension separations.

In one embodiment, the second dimension separation apparatus may comprise, for example, an LC column such as, for example, one or more nanoscale capillary reversed-phase liquid chromatography columns, wherein each sample fraction may be separated into a plurality of sub-fractions based on hydrophobicity. In some embodiments, LC apparatus may include capillary for performing a liquid chromatography separation based on, strong cation exchange chromatography (SCX), normal-phase liquid chromatography (NPLC), hydrophilic interaction liquid chromatography (HILIC), or size exclusion chromatography (SEC).Other second dimension separation techniques that separate samples based on other properties may also be used.

Compared to traditional microscale LC, nano-LC uses a smaller diameter capillary with smaller overall volumes. In some embodiments, the LC capillary is a silica capillary having an inner diameter of about 50 microns. In some embodiments, the LC capillary is a silica capillary having an inner diameter of about 25 microns. The smaller capillary volume leads to higher sample concentrations, while nanoscale flow rates (typically 100-200 nL/min) allow electrospray ionization—mass spectrometry (ESI-MS) to be performed from the nano-LC column with the MS operating in a concentration-dependent regime. Furthermore, nano-LC volumes are compatible with first dimension CE separations performed in small diameter capillaries. Traditionally, CE is used as a second dimension separation mode following LC because of the relatively low loading capacity in CE as compared to LC. By taking multiple LC fractions, the total sample amount loaded into each CE separation can be made more compatible with CE. By employing nano-LC instead of microscale LC, the loading requirements of the two separation dimensions become comparable, enabling more effective nano-LC analysis of multiple fractions collected from a first dimension CE separation.

In one embodiment, the second dimension separation of two or more of the sample fractions may take place in parallel such as, for example in an array of second dimension separation capillaries. In other embodiments, each of the sample fractions may be separated in series. For example, each sample fraction may be loaded sequentially into a single second dimension separation device.

In an operation 109, after transfer into the second dimension separation apparatus, each of the sample fractions may be separated into a plurality of sub-fractions (to the extent possible) according to the one or more characteristics selected for by the second dimension separation apparatus. As mentioned above, in some embodiments, the second dimension separation apparatus may include, for example, a nanoscale capillary reversed-phase liquid chromatography apparatus. In one embodiment, the RPLC apparatus may comprise, for example, a fused silica capillary packed with C₁₈-bonded particles, wherein the sample fractions are separated into sub-fractions based on hydrophobicity. In some embodiments, separation into sub-fractions according to hydrophobicity may be performed at a bulk flow rate of between 100-200 nL/min. In some embodiments, separation into sub-fractions according to hydrophobicity may be performed at a bulk flow rate of below 100 nL/min.

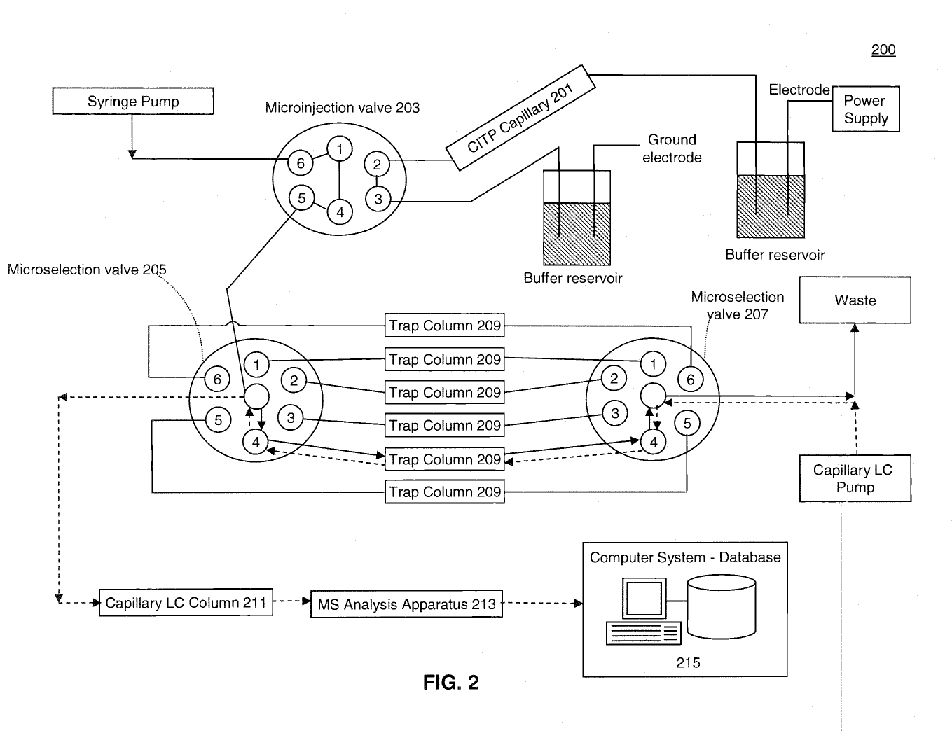

In one embodiment, a nano-LC pump may be employed to generate, for example, a 120-min linear gradient from 5 to 65% acetonitrile at a flow rate of 200 nL/min. In some embodiments, a second 6-port microselection valve may be used to deliver the mobile phase into the individual trap column, followed by a 15-cm-long C₁₈ reversed-phase capillary column (e.g., 50 μm i.d.×365 μm o.d.) for sequential analysis of all CITP fractions collected in the trap columns. Based on the results obtained from studies of certain embodiments, a peak capacity of ˜300 in nano-RPLC can achieved over a run time of 120 min. Because the separation mechanisms in CITP and nano-RPLC are completely orthogonal, in embodiments wherein 30 fractions are taken from the CITP capillary, the combined peak capacity is estimated to be at least 9,000 (30 fractions from CITP×300 from nano-RPLC) over a run time of approximately 65 hrs. In one example, a total of 30 trap columns may be employed to house individual CITP peptide fractions, with only 6 trap columns connected at any given time while using two 6-port microselection valves in the on-line system (see FIG. 2), and with manual connection and disconnection of all 6 trap columns during the CITP peptide fractionation and nano-RPLC peptide separation processes eliminating the need to hold peptide fractions in the CITP capillary. Furthermore, in some embodiments, trap columns containing CITP fractions which are not yet subjected to the second dimension nano-RPLC analysis may be stored at 4° C. to limit diffusion prior to nano-RPLC analysis.

The use of the term “capillary” in this invention is not meant to be restrictive to standard fused silica capillaries, but can also refer to plastic capillaries or microchannels contained within a microfluidic device. In fact, there may be advantages to implimenting certain aspects of the invention in a multidimensional microfluidic system rather than in coupled silica capillaries.

In an operation 111, the separated sub-fractions may then be subject to eluting conditions and eluted from the second dimension separation apparatus. As each sub-fraction is eluted from the apparatus, the sub-fraction may be collected and analyzed, for example, using mass spectrometry [e.g. electroscopy ionization-mass spectrometry (ESI-MS) or matrix-assisted laser desorption/ionization-mass spectrometry (MALDI-MS)], to determine the sample constituents of the sub-fraction. In one embodiment, mass spectroscopic analysis of proteins and other peptides may be assisted by one or more algorithms such as, for example SEQUEST or other algorithms or analysis to determine the amino acid sequence of individual protein or peptide constituents of the sub-fractions.

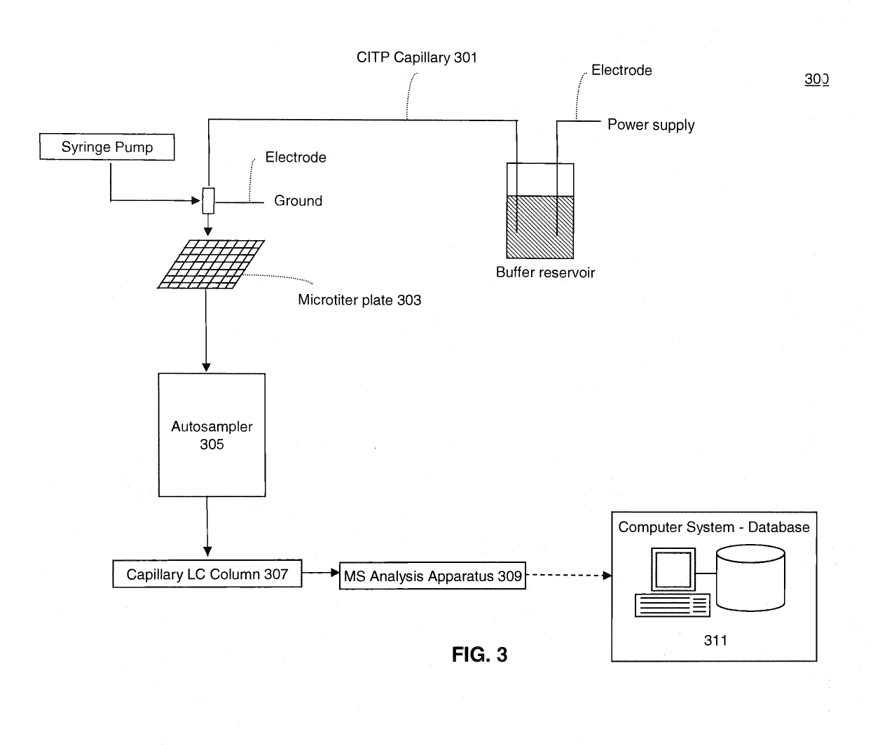

FIGS. 2 and 3 illustrate example systems for multidimensional separation of heterogeneous biomolecular samples, such as, for example, proteins and other peptides, using CITP. FIG. 2 illustrates an example of an on-line system 200 for multidimensional separation using CITP, including a CITP capillary 201 (which may include a CITP only column, a CITP/CZE column, or other electrophoretic column that at least partially utilizes CITP), microinjection valve 203, microselection valves 205 and 207, trap columns 209, capillary LC column 211, analysis apparatus 213, a computer system/database 215, and/or other elements.

FIG. 3 illustrates an example of an off-line system 300 for multidimensional separation using CITP, including a CITP capillary 301 (which may include a CITP only column, a CITP/CZE column, or other electrophoretic column that at least partially utilizes CITP), microtiter plate 303 (or other solid structures capable of keeping fractions separate from one another), autosampler 305 (or other transfer mechanism), capillary LC column 307, analysis apparatus 309, a computer system/database 311, and/or other elements.

Other embodiments, uses and advantages of the invention will be apparent to those skilled in the art from consideration of the specification and practice of the invention disclosed herein. The specification should be considered exemplary only, and the scope of the invention is accordingly intended to be limited only by the following claims.

We claim:

1. A method for performing multi-dimensional separation and analysis of a heterogeneous biomolecular sample, the method comprising:
introducing the heterogeneous biomolecular sample into an electrophoresis capillary;
separating the heterogeneous biomolecular sample into a plurality of fractions using at least capillary isotachophoresis;
introducing at least one of the plurality of fractions into at least one liquid chromatography capillary;
concentrating the at least one of the plurality of fractions at a first end of the at least one liquid chromatography capillary;
separating the at least one of the plurality of fractions into a plurality of sub-fractions using the at least one liquid chromatography capillary; and
eluting each of the plurality of sub-fractions from a second end of the at least one liquid chromatography capillary.

2. The method of claim 1, wherein separating the heterogeneous biomolecular sample into a plurality of fractions using at least capillary isotachophoresis further comprises separating the heterogeneous biomolecular sample into a plurality of fractions using at capillary isotachophoresis and capillary zone electrophoresis.

3. The method of claim 1, wherein the at least one liquid chromatography capillary comprises a capillary for performing a liquid chromatography separation based on one of: reversed-phase liquid chromatography (RPLC), strong cation exchange chromatography (SCX), normal-phase liquid chromatography (NPLC), hydrophilic interaction liquid chromatography (HILIC), or size exclusion chromatography (SEC).

4. The method of claim 1, wherein the at least one liquid chromatography capillary comprises a nano-reversed-phase liquid chromatography capillary.

5. The method of claim 1, wherein separating the at least one of the plurality of fractions into a plurality of sub-fractions using the at least one liquid chromatography capillary comprises separating the at least one of the plurality of fraction into a plurality of sub-fractions according to hydrophobicity.

6. The method of claim 1, further comprising identifying constituent biomolecules of each of the sub-fractions.

7. The method of claim 6, wherein identifying constituent biomolecules of each of the sub-fractions further comprises analyzing the plurality of sub-fractions using mass spectroscopy.

8. The method of claim 7, wherein analyzing the plurality of sub-fractions using mass spectroscopy further comprises analyzing the plurality of sub-fractions using one of electroscopy ionization-mass spectrometry (ESI-MS) or matrix-assisted laser desorption/ionization-mass spectrometry (MALDI-MS).

9. The method of claim 1, wherein introducing at least one of the plurality of fractions into at least one liquid chromatography capillary further comprises eluting the at least one of the plurality of fractions from the electrophoresis capillary electrokinetically.

10. The method of claim 1, wherein introducing at least one of the plurality of fractions into at least one liquid chromatography capillary further comprises eluting the at least one of the plurality of fractions from the electrophoresis capillary using hydrodynamic pressure.

11. The method of claim 1, wherein introducing at least one of the plurality of fractions into at least one liquid chromatography capillary further comprises eluting the at least one of the plurality of fractions from the electrophoresis capillary onto at least one solid structure and transferring the at least one of the plurality of fractions from the at least one solid structure to the at least one liquid chromatography column.

12. The method of claim 1, wherein introducing at least one of the plurality of fractions into at least one liquid chromatography capillary further comprises eluting the at least one of the plurality of fractions from the electrophoresis column into a trap column and eluting the at least one of the plurality of fractions from the trap column into the at least one liquid chromatography column.

13. A system for performing multi-dimensional separation and analysis of a heterogeneous biomolecular sample, comprising:
an electrophoresis apparatus that separates the heterogeneous biomolecular sample into a plurality of fractions by at least capillary isotachophoresis;
a liquid chromatography apparatus that concentrates at least one of the plurality of fractions and separates the at least one of the plurality of fractions into a plurality of sub-fractions; and
a transfer mechanism that transfers at least one of the plurality of fractions from the electrophoresis apparatus into the liquid chromatography apparatus.

14. The system of claim 13, wherein the electrophoresis apparatus separates the heterogeneous biomolecular sample into, a plurality of fractions by capillary isotachophoresis and capillary zone electrophoresis.

15. The system of claim 13, wherein liquid chromatography apparatus comprises a capillary for performing a liquid chromatography separation based on one of: reversed-phase liquid chromatography (RPLC), strong cation exchange chromatography (SCX), normal-phase liquid chromatography (NPLC), hydrophilic interaction liquid chromatography (HILIC), or size exclusion chromatography (SEC).

16. The system of claim 13, wherein the liquid chromatography apparatus comprises at least one nano-reversed-phase liquid chromatography capillary.

17. The system of claim 16, further comprising a sample analysis apparatus that identifies constituent biomolecules of each of the sub-fractions.

18. The system of claim 17, wherein the sample analysis apparatus identifies constituent biomolecules of each of the sub-fractions using mass spectroscopy.

19. The system of claim 18, wherein the sample apparatus identifies constituent biomolecules of each of the subfractions using one of electroscopy ionization-mass spectrometry (ESI-MS) or matrix-assisted laser desorption/ionization-mass spectrometry (MALDI-MS).

20. The system of claim 13, wherein the at least one of the plurality of fractions is eluted from the electrophoresis apparatus electrokinetically prior to transfer into the liquid chromatography apparatus.

21. The system of claim 13, wherein the at least one of the plurality of fractions is eluted from the electrophoresis apparatus using hydrodynamic pressure prior to transfer into the liquid chromatography apparatus.

22. The system of claim 13, wherein the transfer mechanism transfers the at least one of the plurality of fractions onto at least one solid structure and then transfers the at least one of the plurality of fractions from the at least one solid structure into the liquid chromatography apparatus.

23. The system of claim 13, the transfer mechanism transfers the at least one of the plurality of fractions into a trap column and then transfers the at least one of the plurality of fractions from the trap column into the liquid chromatography apparatus.
